(19) United States
(12) Patent Application Publication
(10) Pub. No.: US 2003/0186570 A1
(43) Pub. Date: Oct. 2, 2003

(54) Electronic apparatus having a plurality of connectors for card like devices

(75) Inventor: Takafumi Ito, Tokyo (JP)

Correspondence Address: PILLSBURY WINTHROP, LLP, P.O. BOX 10500, MCLEAN, VA, 22102, US

(73) Assignee: Kabushiki Kaisha Toshiba, Tokyo (JP)

(21) Appl. No.: 10/400,547

(22) Filed: Mar. 28, 2003

(30) Foreign Application Priority Data
Mar. 28, 2002 (JP) 2002-090395

(51) Int. Cl. H01R 12/00

(52) U.S. Cl. 439/79

(57) ABSTRACT

An electronic apparatus that can receive two or more card like electronic devices (card devices) is disclosed. The card device, when received in the electronic apparatus, inclines relatively to the other card device received by the electronic apparatus. Card connectors are arranged in the electronic apparatus so that they can receive the card devices in such way.

### BACKGROUND OF THE INVENTION

### CROSS-REFERENCE TO RELATED APPLICATIONS

This application is based upon and claims the benefit of priority from prior Japanese Patent Application No. 2002-090395, filed Mar. 28, 2002.

1. Field of the Invention

The present invention relates to an electronic apparatus can contains a detachable card like device (hereinafter called a card device), particularly to structure of a connector and a bay for the card device in the electronic apparatus.

2. Description of Related Art

In recent years, portable electronic apparatus such as portable computers of a notebook or palm type, personal digital assistants (PDAs), digital cameras, cellular phones are getting smaller and lighter to make them more convenient. In order to extend the functions of such an electronic apparatus, card devices are used. For example, PC cards, the specification of which is defined jointly by Personal Computer Memory Card International Association (PCMCIA) and Japan Electronic Industry Development Association (JEIDA), are widely used. Also, Card devices of smaller size, such as a SD memory card and a SDIO card, are recently used for data memory, local area network (LAN) communication, wireless communication, and so on. However, since one card device has a restricted function, simultaneous use of two or more card devices is desired.

An electronic apparatus using two or more card devices simultaneously is disclosed in U.S. Pat. No. 6,002,605, and disclosed in U.S. Pat. No. 6,010,066. U.S. Pat. No. 6,002,605 discloses a connecting apparatus which having two slots to hold two card devices of different types and sizes. The two card devices inserted in the two slots respectively are located in parallel with each other.

U.S. Pat. No. 6,010,066 discloses a portable terminal device which has two or more detachable IC card devices. The IC card devices inserted in the portable terminal are piled up with each other and shifted to each other by a predetermined distance in the longitudinal direction on the main surface of the IC card device.

The card devices taken into consideration in U.S. Pat. Nos. 6,002,605 and 6,010,066 are ones in a flat form, and do not have components thereon. Thus, in the prior art, when card devices having various thickness to perform various kinds of functions are used, once one card device is attached, another card device cannot be attached or detached.

Disclosed in U.S. Pat. No. 6,010,066 is that the second IC card device inserted over the first one bends a little bit to be positioned in the slot. But, the bent portion of the card device suffers stress, and the IC card device is eventually destructed.

### SUMMARY OF THE INVENTION

Embodiments of the present invention provide an electronic apparatus and connector structure that can hold two or more detachable card devices of different thickness to be piled up with each other without bending.

According to an embodiment of present invention, an electronic apparatus comprising: a first card connector for receiving a card device, the first card connector including first contacts for electrical connection between the card device and the electronic apparatus; a second card connector for receiving another card device, the second card connector including second contacts for electrical connection between the another card device and the electronic apparatus; and the second card connector, when positioned in the electronic apparatus, inclining relatively to the first card connector in a direction of reception of a card device.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention in which:

FIG. 1A and FIG. 1B illustrate perspective views of a PDA which is an embodiment of the present invention;

FIG. 2 illustrates a perspective view of a cellular phone which is another embodiment of the present invention;

FIG. 3 shows a front view of the openings of slots where detachable card devices are held;

FIGS. 4A to 4D illustrate views in different direction a SD (secure digital) card 11 that is used in the embodiments of the present invention;

FIGS. 5A and 5B illustrate bottom and lateral views of an expansion card 21 used in the embodiments of the present invention;

FIGS. 6A and 6B illustrate bottom and lateral views of a Bluetooth (TM) card used in the embodiments of the present invention;

FIGS. 7A and 7B illustrate bottom and lateral views of a camera module card used in the embodiments of the present invention;

FIGS. 8A and 8B illustrate bottom and lateral views of a PHS (personal handy phone system) card 213 used in the embodiments of the present invention;

FIGS. 9A and 9B illustrate bottom and lateral views of a LAN (local area network) card used in the embodiments of the present invention;

FIGS. 10A and 10B illustrate cross-sections of the electronic apparatus shown in FIG. 3, taken along lines A-A′ and B-B′ respectively;

FIG. 10C shows a spacer used in the connector structure shown in FIGS. 10A and 10B;

FIGS. 11A, 11B, 12, and 13 show how the connector structure of the first embodiment works to hold card devices of different thickness;

FIGS. 14A and 14B show a card device connector applicable to the first embodiment of the present invention;

FIG. 15 shows connector structure of the second embodiment of the present invention;

FIGS. 16A and 16B show a card device connector applicable to the second embodiment of the present invention;

FIG. 17 shows connector structure of the third embodiment in accordance with the present invention;

FIGS. 18A and 18B show a card device connector applicable to the third embodiment of the present invention;

FIGS. 19 and 20 show connector structures of the fourth and fifth embodiments in accordance with the present invention.

### DETAILED DESCRIPTION OF A PREFERRED EMBODIMENT OF THE INVENTION

Embodiments of the invention will be described with reference to the accompanying drawings.

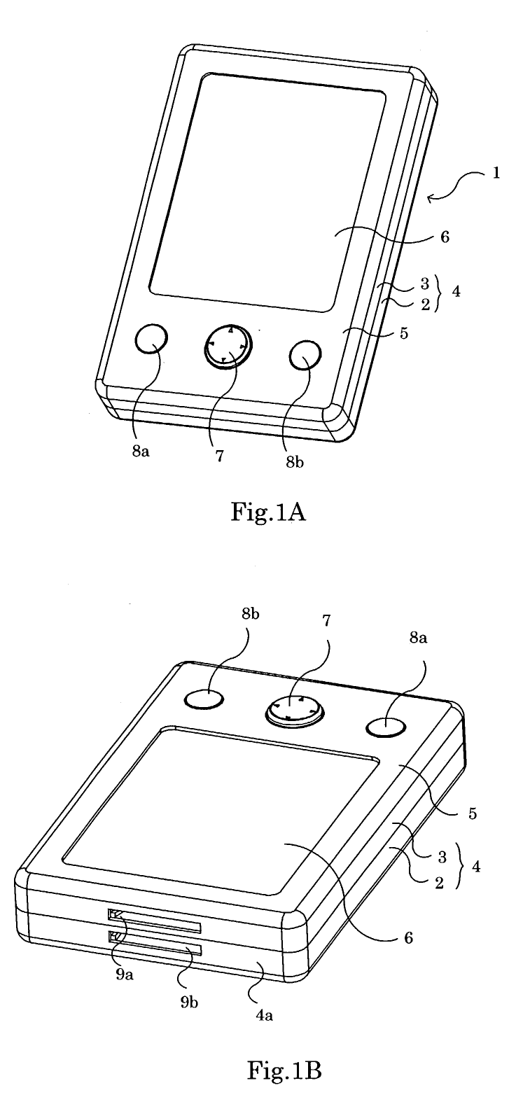

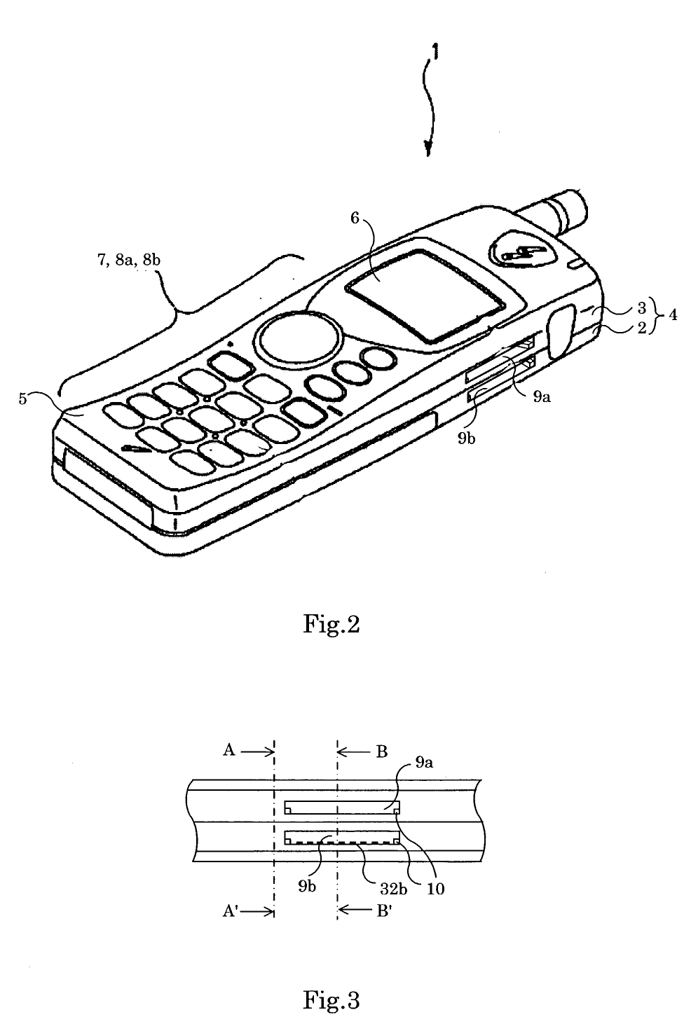

FIGS. 1 to 3 show examples of an electronic apparatus 1 that embodiments of the present invention are applied to. FIGS. 1A and 1B show a PDA. FIG. 2 shows a cellular phone. As shown in FIGS. 1B, 2 and 3, electronic apparatus 1, such as the PDA and the cellular phone, has two card device slots 9a and 9b.

The body of the electronic apparatus 1 shown in FIGS. 1A and 1B has a case 4 which includes a lower case 2 and an upper case 3. The electronic apparatus 1 has a display unit 6 on the upper surface 5. While it is not explained in detail, the display unit 6 is equipped with an input device, such as a pen pad.

A cursor button 7 and operation buttons 8a and 8b are located on the upper surface 5 of the electronic apparatus 1. In consideration of operability, the cursor button 7 and the operation buttons 8a and 8b are arranged below the display unit 6. Thus, when a user holds the electronic apparatus 1 in the palm of his or her hand, the user can operates the cursor button 7 and the operation buttons 8a and 8b watching the display unit 6.

The electronic apparatus 1 has two card device slots 9a and 9b overlapped with each other on the top surface of the case 4 of the PDA 1. They may locate on the side of the case 4 in the cellular-phone 1 shown in FIG. 2. The electronic apparatus 1 may have three or more card slots.

The card slots 9a and 9b have guide members 10 to fit the form of a card device (explained later), so that a user cannot insert the card device into the slots upside down.

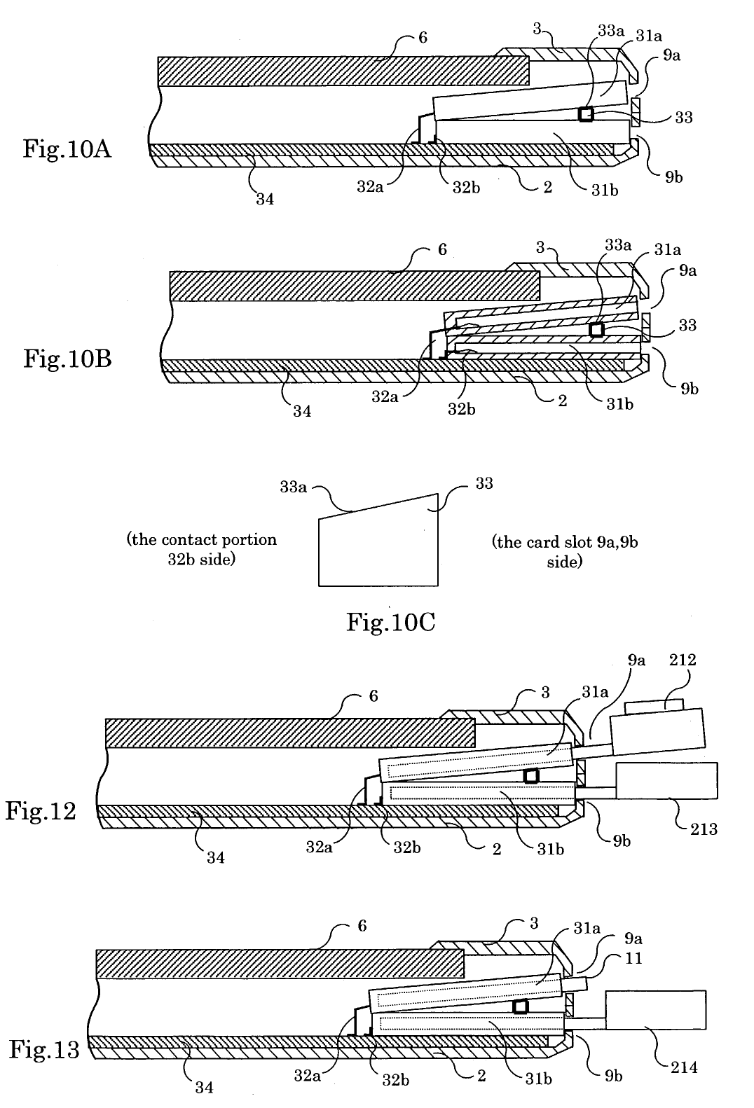

Card connectors 31a and 31b shown in FIGS. 10A and 10B (explained later) are provided within the body of the electronic apparatus respectively for the slots 9a and 9b to guide and hold the detachable card devices. The card connectors 31a and 31b have at least the members of guiding a card device when a user inserts the card into the slot 9a or 9b, of holding the card device when the card device is positioned in a workable position, and of making electrical connection between the card device and the electronic apparatus 1. The card connector 31a and 31b may be an integral unit or combination of separate parts.

As shown in FIGS. 11A and 11B, these card connectors 31a and 31b are arranged within the electronic apparatus 1 so that the directions insertion or holding of a card device in the two connectors 31a and 31b make the angle θ (theta) between 0 degree and 90 degrees. That is, one of the card connectors 31a and 31b inclines relatively to the other.

In the first embodiment, the card connector 31b for the card slot 9b parallels the bottom of the case 4 or PCB (main printed circuit board) 34 shown in FIGS. 10A and 10B. On the other hand, the card connector 31a for the card slot 9a inclines relatively to the bottom of the case 4 or the PCB 34.

Thus, as shown in FIG. 3, the electric contacts 32b of the connector 31b can be seen from the top in the PDA or from the side in the cellular phone, but those of the connector 31a cannot.

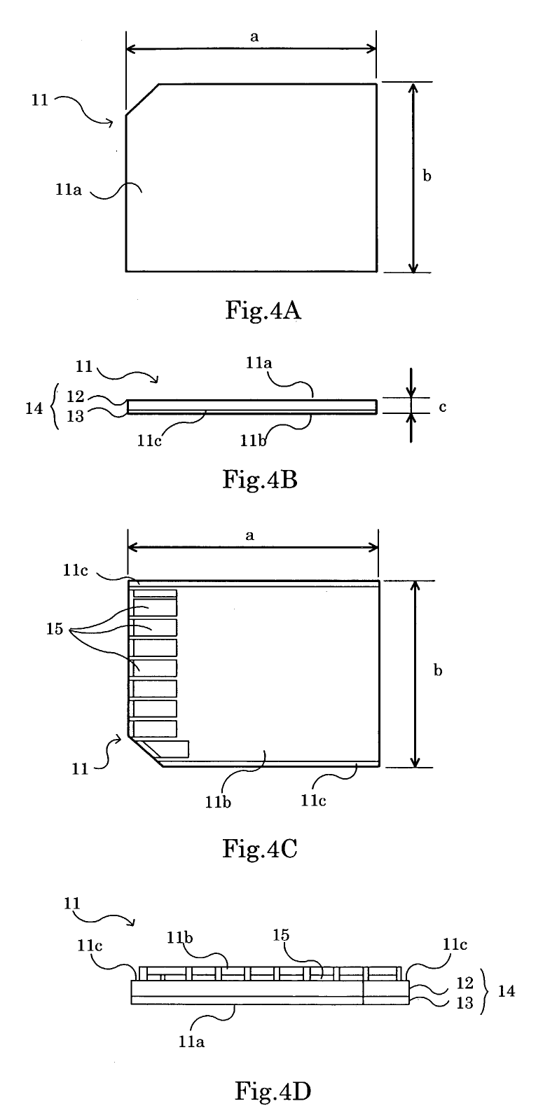

FIGS. 4A, 4B, 4C and 4D show the appearance of the thin-shaped memory card device, such as an SD card, which is an example of a portable electronic media to be used in the electronic apparatus 1.

FIGS. 4A through 4D are a bottom view, a lateral view, a front view, and a top surface view of the thin-shaped memory card, respectively.

The memory card device 11 shown in FIG. 4 contains a substrate on which electronic components, such as a memory chip, are mounted. The memory card device 11 has a lower case 12 and an upper case 13, which form a case 14 in combination to cover the substrate.

The memory card device 11 has the size of a length (L) of a, a width (W) of b, and a thickness (T) of c. For example, the SD memory card has the size of 32 mm (L)×24 mm (W)×2.1 mm (W).

The surface 11a of the case 12 of the memory card device 11 is flat to stick a seal.

There are contact pads 15 for electrical connection between the card device 11 and the electronic apparatus 1 on the surface 11b of the case 14. The contact pads 15 are arranged in a row with a predetermined interval at the longitudinal end portion of the surface 11b. The contact pads 15 are provided to supply a power to the memory card device 11 and to transfer data or control signals between the memory card device 11 and the electronic apparatus 1. Guide portions 11c are formed on both of the longitudinal sides of the surface 11b.

The memory card device 11 is inserted in the card slot 9a or 9b, guided by the guide portions 11c and the guide member 10 of the card slot 9a or 9b shown in FIG. 3. Thereby, the contact pads 15 properly face the contacts of the card connector 31a or 31b so that the upside down insertion of the memory card device 11 is prevented.

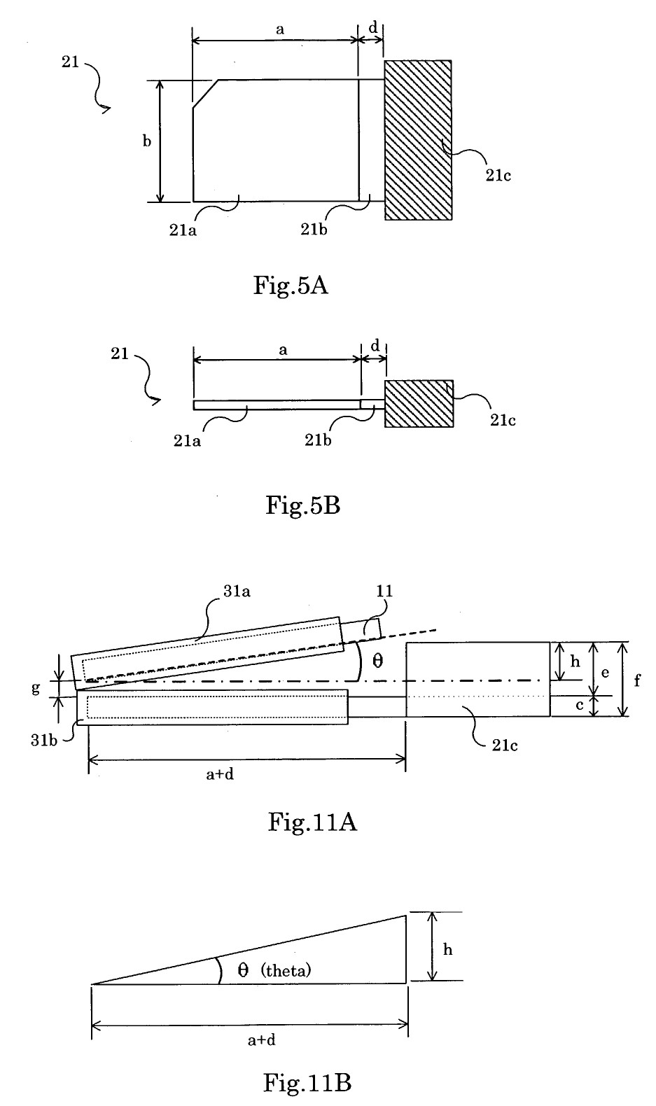

According to the figures of from FIG. 5 through FIG. 9, an expansion card device 21, such as an SDIO card, which is one of portable electronic equipments to be used in the electronic apparatus 1 will be explained.

The expansion card device 21 is allowed in its standard specification to have a connection part 21b and an extended part 21c in addition to a main portion 21a that has the same form factor of a (L)×b(W)×c(T) as that of the thin-shaped memory card device shown in FIG. 4. The length of d of the connection part 21b is defined in the standard specification (for example, in the case of a SDIO card, d=5 mm). On the other hand, as for the extended part 21c, which is for equipping a card device with circuits or components performing various kinds of extended functions, its size or form factor is not defined in the standard specification.

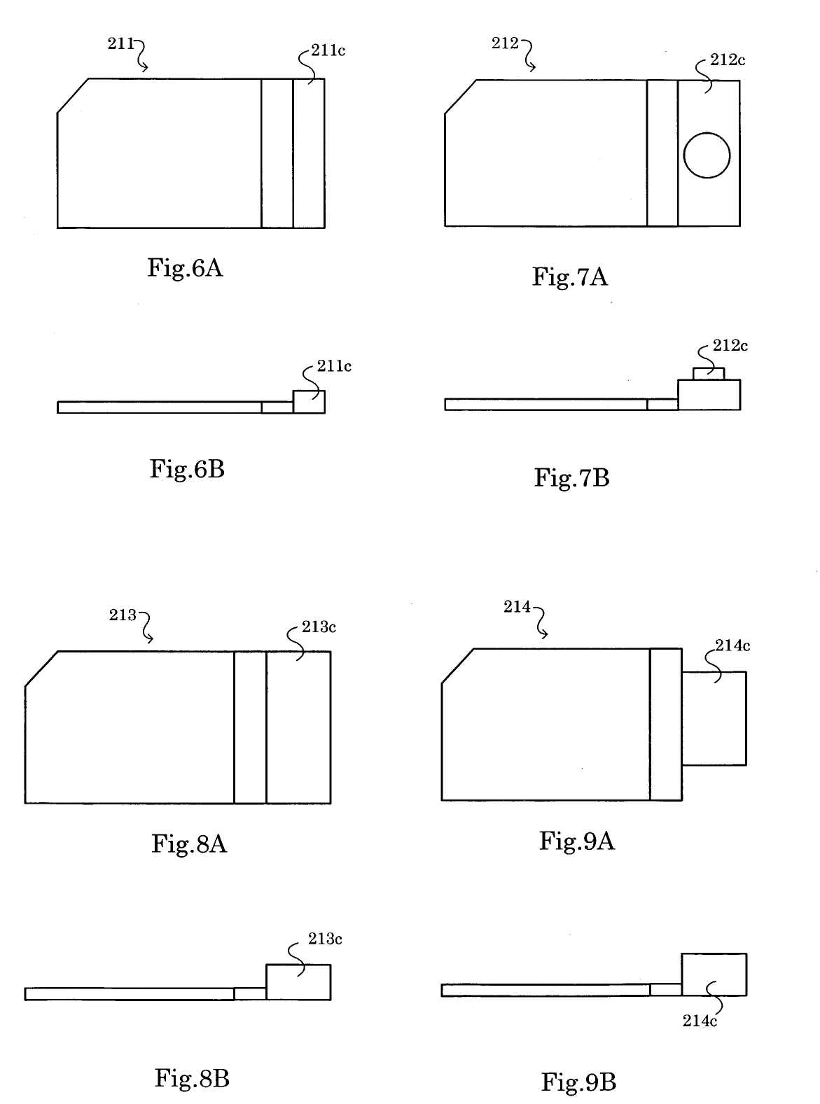

For an example of the expansion card device, FIGS. 6A and 6B show Bluetooth (TM) card device 211. The Bluetooth (TM) card device 211 has an antenna in the extended part 21c. FIGS. 7A and 7B show a camera module card device 212 which has a CCD and lens unit 212c in the extended part 21c. FIGS. 8A and 8B show a PHS card 213. The PHS card has a communication unit 213c with an antenna in the extended part 21c. FIGS. 9A and 9B show a LAN card 214. The LAN card 214 has an external connector 214c in the extended part 21c.

(The first embodiment)

According to FIGS. 10 through 14, the internal structure of the card slots 9a and 9b of the electronic device 1 will be explained.

FIG. 10A is a cross-sectional view of the electronic apparatus taken along the line A-A′ in FIG. 3. FIG. 10B is a cross-sectional view of the electronic apparatus taken along the line B-B′ in FIG. 3. FIG. 10C shows a spacer 33 provided between the card connectors 31a and 31b. As shown in FIGS. 10A and 10b, a printed circuit board (PCB) 34 is provided in parallel with the lower case 2 within the electronic apparatus 1. The card connector 31b is mounted on a surface of the PCB 34 in the opposite side of the lower case 2. The card connector 31b has an opening for the card device to be inserted. The card connector 31b is mounted on the PCB 34 so that the opening of the card connector 31b may align with the opening of the card slot 9b when the PCB is mounted on the lower case 2. The electrical contacts, pins or pads 32b are arranged in the opposite end of the opening end of the card connector 31b and connected to the circuits of PCB 34. The contacts 32b are for electrical connection of the contact pads 15 of the card device with the circuits of the PCB 34.

Card connector 31a is arranged over the card connector 31b with a spacer 33. As shown in FIG. 10C, the top surface 33a of the spacer 33 is inclined at the angle θ (theta) which is greater than 0 degrees and less than 90 degrees. That is to say, the height of the spacer 33 in the side of the card slot (9a or 9b) side of the spacer 33 is greatr than that in the side of the contact portion 32b. As shown in FIGS. 10A and 10B, the card connector 31a has an opening for the card device to be inserted. The card connector 31a is positioned along the inclined top surface 33a of the spacer 33 so that the opening of the card connector 31a can align with the opening of the card slot 9a formed in the upper case 3. The electrical contacts, pins or pads 32a are arranged in the end of the card connector 31a opposite to the opening end thereof. The contacts 32a is for electrical connection of the contact pads 15 of a card device with electronic circuits of PCB 34. The contacts 32a are extended from the card connector 31a to be connected to the circuits of the PCB 34. Therefore, the card insertion direction of the card connector 31a is inclined at the predetermined angle θ (theta) to the card insertion direction of card connector 31b with the card connector 31a supported by the card connector 31b at the contact end of the card connector 31a and by the spacer 33.

According to FIGS. 11A and 11B, the suitable angle of inclination of card connector 31a will be explained using an SD memory card as the thin-shaped memory card 11 and a various SDIO card as the expansion card 21. In this preferred embodiment, the size of the SDIO card may be defined as follows: (a) the thickness c of the body of the SDIO card is 2.1 mm, (b) the height e of the projection of the extended part 21c is 5.0 mm, and (c) the maximum thickness f of the extended part 21c is 7.1 mm. The distance g which corresponds with the distance between the opposed edges of card devices held in the card connectors 31a and 31b may be 1 mm. Supposed that the card connector 31a is located in parallel with the card connector 31b, when the expansion card device is held by the card connector 31b, the upper portion of 4 mm (h=e−g) in height of the extended part 21c will overlap the card slot 9a. Thus, the overlapped portion of the extended part 21c will interfere with insertion or extraction of a card device into or from the card connector 31a. To avoid it, the inclination angle θ (theta) is set to be greater than 6.2 degrees which is obtained by the following equation.

sin θ(theta)=h/(a+d)=4/37

The inclination angle θ (theta) of the card connector 31a may be 7 degrees so that insertion and extraction of a card in the card connector 31a is not interfered with, even if the card connector 31b holds the expansion card device 21c having the extended part 21c with the maximum thickness 7.1 mm.

Provided that the length (a+d) in FIGS. 11A and 11B is 37 mm, as the thickness f of the extended part 21c increases or decreases by 1 mm, the inclination angle θ (theta) of the card connector 31a increases or decreases by about 1.5 degrees. When the inlination angle θ (theta) of the card connector 31a exceeds 10 degrees, the thickness f of the extended part 21c of a expansion card device to be hold in the card connector 31b may exceed 10 mm. Although it depends on extended functions expected to be performed by an expansion card, in this embodiment, preferably, the inclination angle θ (theta) may be larger than 0 degrees and equal to and smaller than 10 degrees in consideration of portability and utility of the expansion card. In addition, the inclination angle θ (theta) of the card connector 31a may be out of the range mentioned above depending on configuration of the components of the electronic apparatus 1, such as PCB 34 and/or a display unit 6. The electronic apparatus 1 may have two or more card connectors with the inclination angles θ (theta) which is greater than 0 degrees and less than 45 degrees.

FIG. 12 and FIG. 13 show expansion cards received by the electronic apparatus 1 of the first embodiment of the present invention. FIG. 12 shows the electronic apparatus 1 receiving a camera module card 212 in the card connector 31a and a PHS card 213 in the card connector 31b. In this embodiment, by inserting into the upper card connector 31a the camera module card 212 having the extended part 21c which is thicker than that of the PHS card 213, both of the expansion cards 212 and 213 can be inserted and extracted without increase of the thickness of the electronic apparatus 1.

FIG. 13 shows the electronic apparatus 1 receiving a thin-shaped memory card device 11 in the card connector 31a and a LAN card device 214 in the card connector 31b.

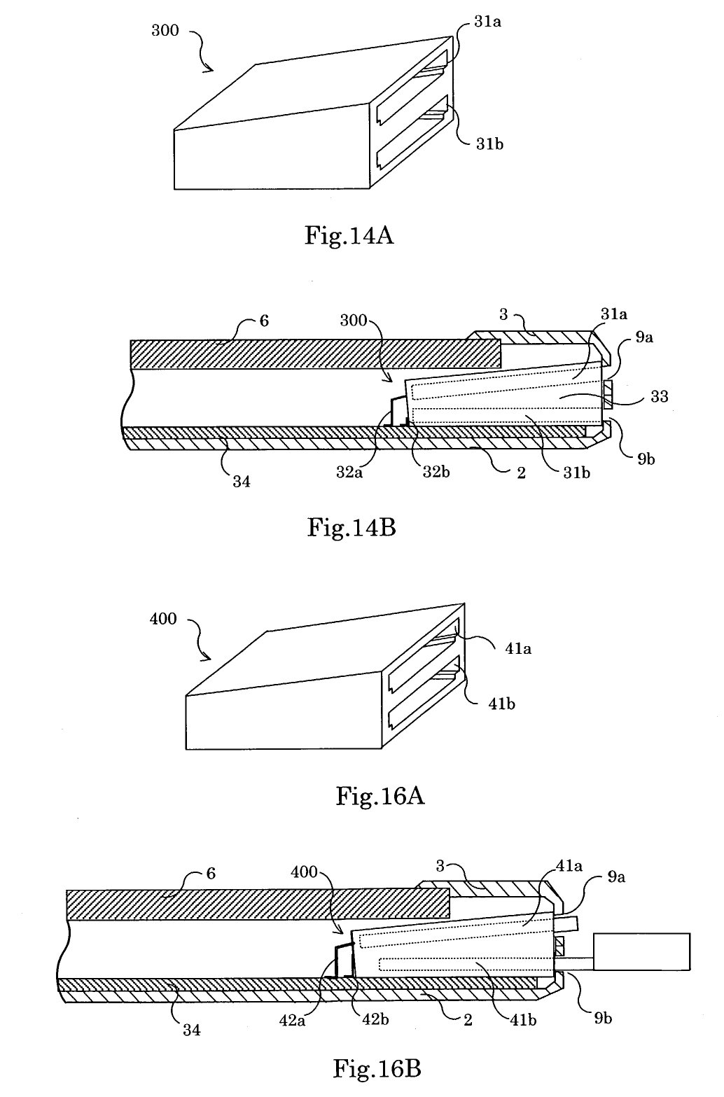

FIGS. 14A and 14B show another embodiment of the card connector where the card connectors 31a and 31b shown in FIGS. 10A and 10B are formed in a unit 300. FIGS. 14A and 14B show a perspective view and a cross-sectional view of the card connector unit 300. The spacer 33 shown in FIGS. 10A, 10B and 10C is not necessary in this embodiment. Since card devices are received by chambers 31a and 31b of the card connector 300 in the same way as by the card connectors 31a and 31b in FIGS. 10A and 10B, the detailed explanation of the card connector unit 300 is omitted. The card connector unit 300 may be integrally formed or a combination of separate components, such as guide rails. As shown in FIG. 14, use of the card connector unit 300 makes it easier to assemble the electronic apparatus.

(The Second Embodiment)

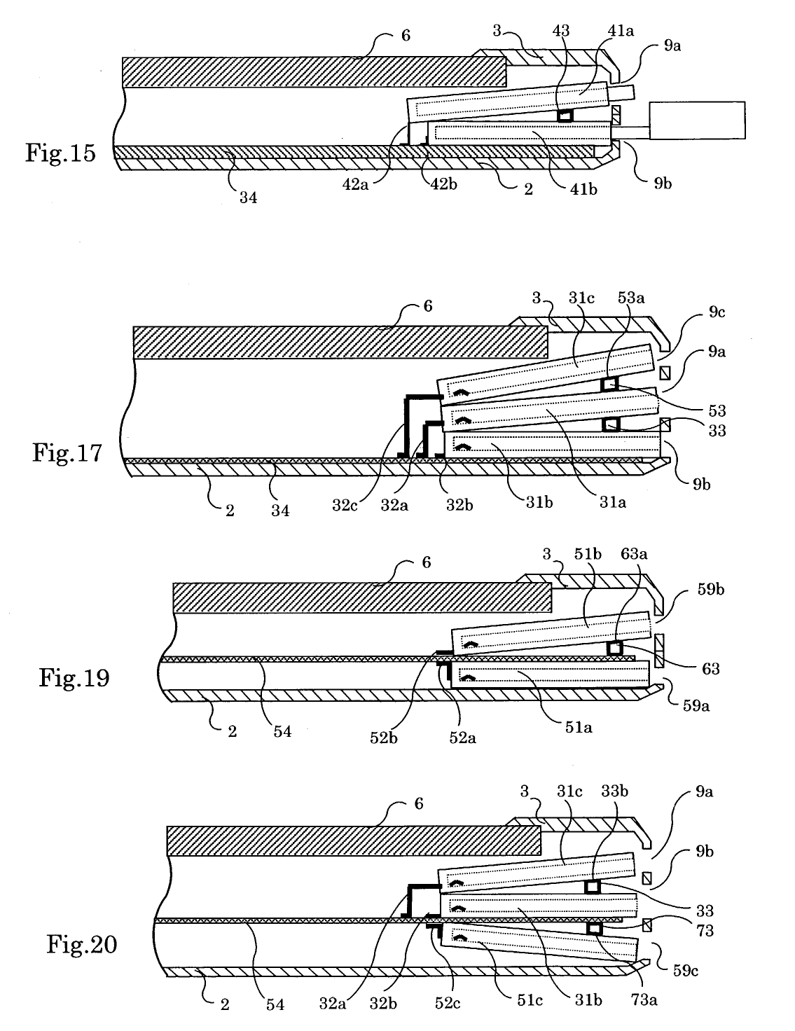

FIG. 15 shows a cross-sectional view of another embodiment of the present invention. In the electronic apparatus 1 shown in FIG. 15, the card connector 41b is arranged in parallel to the PCB 34 mounted on the lower case 2 so that the opening of the card connector 41b aligned with the card slot 9b formed in the lower case 2. Electrical contacts, pins or pads 42b are arranged in the end of the card connector 41b that is opposite to the opening of the card connector 41b. The contacts 42b are for electrical connection with the contact pad 15 of the card. The contacts 42b are connected to electrical circuits of the PCB 34. The second embodiment is different from the first embodiment in that the length of the card connector 41b in the card insertion direction is shorter than that of the card connector 41a. That is, the length of the card received in the card connector of the second embodiment is shorter (shallower) than that of the first embodiment. The card connector 41a is arranged over the card connector 41b with the spacer 42 between the card connectors 41a and 41b. The end of the card connector 41a having the electric contacts 42a overhangs from the end of the card connector 41b. The top surface 43a of the spacer 43 is inclined. The spacer 43a has the same feature as the spacer 33 shown in FIG. 10c. The spacer 43, however, can be smaller in height than the spacer 33 by shifting the card connector 41a in the card insertion direction.

The card connector 41a has an opening which is aligned with the card slot 9a of the upper case 3 when provided in the electronic apparatus 1, and electrical contacts, pins or pads 42a in the opposite end. The contacts 42a are for electrical connection between the contact pads 15 of an inserted card device and circuits of the PCB 34. In the present embodiment, the closed end of the card connector 41a is positioned lower than that in the first embodiment. Thus, the electronic apparatus 1 can be made thinner.

FIGS. 16A and 16B show another embodiment of the card connector where the card connectors 41a and 41b shown in FIG. 15 are formed in a unit 400. FIGS. 16A and 16B show a perspective view and a cross-sectional view of the card connector unit 400. The spacer 33 shown in FIG. 15 is not necessary in this embodiment. Since card devices are received by chambers 41a and 41b of the card connector 400 in the same way as by the card connectors 41a and 41b in FIG. 15, the detailed explanation of the card connector unit 400 is omitted. The length of the card receiving chamber 41b is shorter than that of the chamber 41a. The chamber 41a extends toward behind the end of the chamber 41b. The card connector unit 400 may be integrally formed or a combination of separate components, such as guide rails. As shown in FIG. 16B, use of the card connector unit 400 makes it easier to assemble the electronic apparatus.

(The Third Embodiment)

FIG. 17 shows a cross-sectional view of the electronic apparatus 1 having three card slots. In the third embodiment, two spacers 33 and 53 are provided between the card connectors 31a, 31b and 33c. Like spacer 33 shown in FIG. 10C, the spacer 53 has a inclined top surface 53a. The inclination angle of the top surface 53a of the spacer 53 is larger than that of the top surface 33a of the spacer 33 so that the card connector 31C is inclined at the larger degree than the card connector 31a. Like the card connectors 31a and 31b, the card connector 31c has an opening through which a card device is inserted, and electric contacts, pins or pads for electrical connection of the contact pads 15 of the card and circuits of the PCB 34.

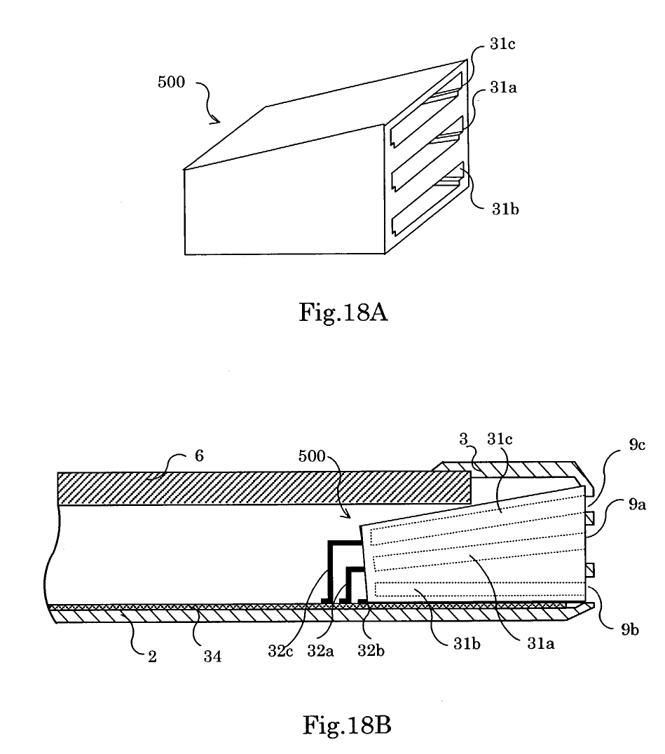

FIGS. 18A and 18B are figures showing a card connector unit for the third embodiment of the present invention. FIGS. 18A and 18B are a perspective view and a cross-sectional view of the card connector unit 500 which includes the above-mentioned card connectors 31a, 31b and 31c in one unit. The card connector unit 500 may be an integral unit or a combination of separate parts, such as guide rails. The card connector unit 500 requires no spacer 33 or 53. The card connector 500 makes it easy to assemble the electronic apparatus 1.

(The Fourth Embodiment)

FIG. 19 shows the fourth embodiment of the present invention. Card connectors 51a and 51b are mounted on the both sides of the PCB 54. This feature is preferable in the case that a PCB of a double-sided part mounting type, on both sides of which electric parts are mounted, is used. The card connector 51a is arranged on and in parallel to the PCB 54. The opening of the card connector 51a is aligned with card slot 59a in the lower case 2 when fixed in the electronic apparatus 1. The card connector 51a has pins or pads 52a for electric connection between a card device inserted and electric circuit of the PCB 54. Card connector 51b is mounted on the other side of PCB 54 with a spacer 63 between the card connector 51b and the PCB 54. Like the spacer 33 shown in FIG. 10C, the top surface 63a of the spacer 63 is inclined. Aligned with the top surface 63a of the spacer 63, the card connector 51b is tilted toward the slot 59b when assembled in the electronic apparatus 1. Like the card connector 51a, the card connector 51b includes an opening, and electric contacts, pins or pads. In this embodiment, the thickness of PCB 54 is effective to make a larger space between the card slots 59a and 59b. The inclination angle of the card connector 51b can be made smaller to keep the thickness of the electronic apparatus smaller.

(The Fifth Embodiment)

FIG. 20 shows the fifth embodiment of the present invention which has the features of the first and fourth embodiments shown in FIGS. 10A and 10B and FIG. 19. In the fifth embodiment, the card connector 51c is mounted on the reverse side of the PCB 54 with a spacer 73 between them. The spacer 73 has an inclined top surface 73a. Thus, aligned with the top surface 73a, the card connector 51c is tilted toward the card slot 59c when positioned in the electronic apparatus 1. On the other side of the PCB 54, the card connectors 31a and 31b shown in FIGS. 10A and 10B are mounted on the other side of the PCB 54. The thickness of PCB 54 makes a space between the card connector 31b and the card connector 51c larger. Thus, the inclination or tilt angle of the card connector 51c may be made smaller. Like the card connectors 31b and 31c, the card connector 51c includes an opening through which a card device is inserted, and electric contacts, pins or pads for electrical connection between a card device and circuits of the PCB 54. This embodiment is preferable when a PCB of a double-sided part mounting type is used.

The card connectors for SD and SDIO cards are explained above. However, it is not restricted to those embodiments, and is applicable to card connectors for other types of cards having smaller or larger dimension.

What is claimed is:

1. An electronic apparatus comprising:
a first card connector for receiving a card device, the first card connector including first contacts for electrical connection between the card device and the electronic apparatus;
a second card connector for receiving another card device, the second card connector including second contacts for electrical connection between the another card device and the electronic apparatus; and
the second card connector, when positioned in the electronic apparatus, inclining relatively to the first card connector in a direction of reception of a card device.

2. An electronic apparatus according to claim 1, further comprising a circuit board, and wherein the first card connector is positioned to receive the card in a direction in parallel to a circuit board.

3. An electronic apparatus according to claim 1, wherein the second card connector inclines at an angle which is larger than 0 degrees, and less than and equal to 10 degrees.

4. An electronic apparatus according to claim 2, wherein the second card connector is positioned over the first card connector in the electronic apparatus.

5. An electronic apparatus according to claim 4, further comprising a spacer between the first card connector and the second card connector.

6. An electronic apparatus according to claim 4, wherein the first and second card connectors are formed in a unit.

7. An electronic apparatus according to claim 4, further comprising a third card connector for receiving a card device, the third card connector including third contacts for electrical connection between the received card device and the electronic apparatus, and wherein the third card connector, when positioned in the electronic apparatus, inclines relatively to the first and second card connectors in a direction of reception of the card.

8. An electronic apparatus according to claim 7, wherein the third card connector is positioned over the second card connector.

9. An electronic apparatus according to claim 8, further comprising a spacer between the second connector and the third connector.

10. An electronic apparatus according to claim 8, the first, second and third card connecters are formed in a unit.

11. An electronic apparatus according to claim 7, wherein the first and the second card connectors are positioned in the one side of the circuit board, and the third card connector is positioned in the other side of the circuit board.

12. An electronic apparatus according to claim 1, wherein the first and second card connectors have a guide member for guiding a card when the card is inserted and extracted.

13. An electronic apparatus according to claim 4, wherein the end of the second card receiving part extends toward behind the end of the first card connector.

14. An card connector unit comprising:
a first portion for receiving a first card device;
first electrical contacts for electrical connection between the first card device and an external circuit;
a second portion for receiving a second card device;
second electrical contacts for electrical connection between the second card device and an external circuit; and
the first direction of reception of the first card device in the first portion inclining relatively to the second direction of reception of the second card device in the second portion.

15. A card connector unit according to claim 14, wherein the first direction inclining relatively to the second direction at an angle being larger than 0 degrees, and less than and equal to 10 degrees.

16. A card connector unit according to claim 15, further comprising:
a third portion for receiving a third card device;
third electrical contact for electrical connection between the third card device and an external circuit; and
the third direction of reception of the third card device in the third portion inclining relatively to the first and the second directions.

17. A card connector unit according to claim 14, wherein the first and second portions have a guide member for guiding the first and second cards when inserted.

18. A card connector unit according to claim 14, wherein the second portion is extended toward behind the end of the first portion.

19. A card connector unit according to claim 14, wherein the first and the second portions are integrally formed.
